(19) United States
(12) Patent Application Publication
(10) Pub. No.: US 2025/0198860 A1
(43) Pub. Date: Jun. 19, 2025

(54) PRESSURE SENSOR, PRESSURE SENSING PANEL

(71) Applicants: Beijing BOE Technology Development Co., Ltd., Beijing (CN); BOE Technology Group Co., Ltd., Beijing (CN)

(72) Inventors: Yunke QIN, Beijing (CN); Lei WANG, Beijing (CN); Yue TONG, Beijing (CN); Yanling HAN, Beijing (CN)

(73) Assignees: Beijing BOE Technology Development Co., Ltd., Beijing (CN); BOE Technology Group Co., Ltd., Beijing (CN)

(21) Appl. No.: 19/066,213

(22) Filed: Feb. 28, 2025

Related U.S. Application Data
(63) Continuation of application No. PCT/CN2023/115064, filed on Aug. 25, 2023.

(51) Int. Cl. G01L 1/14

(52) U.S. Cl. CPC G01L 1/14

(57) ABSTRACT

A pressure sensor includes a substrate and a sensing transistor, and the sensing transistor includes: a first active layer, a first sensing gate and a cavity structure. The first active layer is provided on the substrate. The first sensing gate is provided on a side of the first active layer away from the substrate. The cavity structure is provided between the first active layer and the first sensing gate and overlaps with the first sensing gate.

### CROSS-REFERENCE TO RELATED APPLICATION

This application is a continuation application of PCT Application No. PCT/CN2023/115064, filed Aug. 25, 2023, the entire content of which is incorporated herein by reference.

### TECHNICAL FIELD

This disclosure relates to the field of electronic sensing technology, and in particular to a pressure sensor and a pressure sensing panel.

### BACKGROUND

A sensor is a detection device that can sense the information being measured and convert the sensed information into electrical signals or other required forms of information output according to certain rules, so as to meet the requirements of information output, processing, storage, display, recording and control.

Existing sensors use silicon-based MEMS (Micro Electro Mechanical System) technology, which allows the internal structure of the sensor to be in the scale of micrometer or even nanometer, but silicon-based technology cannot meet the needs of large areas and has a relatively low sensitivity. Moreover, sensors require special materials such as piezoresistive materials or piezoelectric materials to achieve the purpose of pressure detection, but the material cost of special materials is relatively high.

It should be noted that the information disclosed in the above background section is only used to enhance understanding the background of this disclosure, and therefore may include information that does not constitute the prior art known to those skilled in the art.

### SUMMARY

This disclosure proposes a pressure sensor and a pressure sensing panel with high detection sensitivity and low production cost.

Other features and advantages of this disclosure will become apparent from the following detailed description, or may be learned in part by the practice of this disclosure.

According to one aspect of this disclosure, a pressure sensor is proposed and includes a substrate and a sensing transistor, where the sensing transistor includes: a first active layer provided on the substrate;
a first sensing gate, provided on a side of the first active layer away from the substrate; and
a cavity structure, provided between the first active layer and the first sensing gate, and overlapping with the first sensing gate.

In an exemplary embodiment of this disclosure, the sensing transistor further includes:
a first insulating layer, provided between the first active layer and the first sensing gate and overlapping with the cavity structure; and
a second insulating layer, covering the first active layer and overlapping with the cavity structure;
where, at least part of the cavity structure is provided inside at least one of the first insulating layer and the second insulating layer.

In an exemplary embodiment of this disclosure, the first insulating layer includes:
a first separation layer, provided between the first active layer and the first sensing gate;
where, the first separation layer is provided with a sacrificial etching hole, the sacrificial etching hole is connected with the cavity structure, and the cavity structure is provided in the first separation layer.

In an exemplary embodiment of this disclosure, the first separation layer includes:
a main body, provided between the first active layer and the first sensing gate; and
a protrusion, protrudingly provided on a side of the main body away from the substrate, where the sacrificial etching hole is provided in the protrusion, and the cavity structure is defined by the protrusion and the second insulating layer.

In an exemplary embodiment of this disclosure, an orthographic projection of the sacrificial etching hole on the substrate is located outside an orthographic projection of the first active layer on the substrate.

In an exemplary embodiment of this disclosure, the first insulating layer further includes:
a first planarization layer, provided between the first separation layer and the first sensing gate and configured to block the sacrificial etching hole.

In an exemplary embodiment of this disclosure, the sensing transistor further includes:
a first insulating cover layer, provided on a side of the first insulating layer away from the substrate and configured to cover the first sensing gate.

In an exemplary embodiment of this disclosure, the sensing transistor further includes:
a first electrode and a second electrode, provided on a surface of the second insulating layer facing the substrate and electrically connected to the first active layer through a via.

In an exemplary embodiment of this disclosure, the second insulating layer includes:
a first gate insulating layer, provided on a side of the first active layer away from the substrate, where the first electrode and the second electrode are electrically connected to the first active layer across the first gate insulating layer; and
a first interlayer insulating layer, provided between the first gate insulating layer and the first insulating layer and configured to cover the first electrode and the second electrode, where the cavity structure is defined by sides, close to each other, of the first interlayer insulating layer and the first insulating layer.

In an exemplary embodiment of this disclosure, the sensing transistor further includes:
a second sensing gate, provided between the first active layer and the substrate, and overlapping with the first active layer; and
a first buffer layer, covering the second sensing gate, where the first active layer is provided on a surface of the first buffer layer away from the substrate.

In an exemplary embodiment of this disclosure, an orthographic projection of the cavity structure on the substrate is located within an orthographic projection of the first active layer on the substrate.

In an exemplary embodiment of this disclosure, a boundary of an orthographic projection of the cavity structure on the substrate is located within a boundary of an orthographic projection of the first sensing gate on the substrate.

In an exemplary embodiment of this disclosure, a projection of the cavity structure relative to the substrate is a circular structure.

In an exemplary embodiment of this disclosure, the cavity structure is filled with gas; or,
the cavity structure is a vacuum structure.

In an exemplary embodiment of this disclosure, the sensing transistor further includes:
a pressing portion, provided on a side of the first sensing gate away from the substrate and provided corresponding to the cavity structure.

In an exemplary embodiment of this disclosure, a number of the cavity structure is two or more, the two or more cavity structures are provided in parallel and spaced apart between the first active layer and the first sensing gate, and orthographic projections of the cavity structures on the substrate are located within an orthographic projection of the first sensing gate on the substrate.

According to another aspect of this disclosure, a pressure sensing panel is proposed and includes the pressure sensor as described above.

In an exemplary embodiment of this disclosure, a number of the pressure sensor is two or more, and the two or more pressure sensors are arranged in an array along a row direction and a column direction, with top gates of sensing transistors in a same column being connected through a scan line, first electrodes of the sensing transistors in a same row being connected through a data line, and second electrodes of the sensing transistors in the same row being connected through an output line.

In an exemplary embodiment of this disclosure, the pressure sensing panel further includes:
a switch transistor, provided on the substrate, where the second electrodes of the sensing transistors are connected to the output line through the switch transistor.

In an exemplary embodiment of this disclosure, the switch transistor includes:
a second active layer, provided on the substrate, where the second active layer is electrically connected to the first active layer and provided in a same layer as the first active layer; and
a first switch gate, provided on a side of the second active layer away from the substrate and provided in a same layer as the first sensing gate.

According to yet another aspect of this disclosure, a method for manufacturing a pressure sensor is proposed and includes the following steps:
forming a first active layer on a substrate;
forming a cavity structure on a side of the first active layer away from the substrate; and
forming a first sensing gate, which overlaps with the cavity structure, on a side of the cavity structure away from the substrate.

In an exemplary embodiment of this disclosure, forming the cavity structure on the side of the first active layer away from the substrate includes the following steps:
forming a second insulating layer on a side of the first active layer away from the substrate;
forming a sacrificial layer, which overlaps with the first sensing gate and the second insulating layer, on a side of the second insulating layer away from the substrate;
forming a first insulating layer for covering the sacrificial layer on a side of the sacrificial layer away from the substrate; and
removing the sacrificial layer to form the cavity structure between the first insulating layer and the second insulating layer.

In an exemplary embodiment of this disclosure, removing the sacrificial layer includes the following steps:
forming a first separation layer on a side of the sacrificial layer away from the substrate;
forming a sacrificial etching hole on the first separation layer;
causing an etching solution to corrode the sacrificial layer by flowing the etching solution into the sacrificial etching hole, thereby forming the cavity structure between the first separation layer and the second insulating layer; and
forming a first planarization layer for blocking the sacrificial etching hole on a side of the first separation layer away from the substrate.

According to the pressure sensor and pressure sensing panel provided by some embodiments of this disclosure, a cavity structure is formed between the first active layer and the first sensing gate. Under the action of external pressure, the cavity structure is deformed, causing the capacitance value between the first active layer and the first sensing gate to change, and the output current of the second electrode in the sensing transistor changes. According to the output current of the second electrode, the pressing force of the first sensing gate can be detected. The output current of the second electrode is different when the pressing force applied to the first sensing gate is different, thereby realizing the detection of different pressing forces. Since the capacitance change directly acts on the first sensing gate of the sensing transistor, the voltage and current signals are converted and amplified, thereby improving the sensitivity of the pressure sensor. In addition, the pressure sensor can realize the detection of pressing force only through the cavity structure, without the need for complex special materials, thereby saving production costs.

It is to be understood that the foregoing general description and the following detailed description are exemplary and explanatory only and are not restrictive of this disclosure.

### BRIEF DESCRIPTION OF THE DRAWINGS

The accompanying drawings herein are incorporated into the specification and constitute a part of the specification, illustrate embodiments consistent with this disclosure, and together with the specification are used to explain the principles of this disclosure. The accompanying drawings described below are only some embodiments of this disclosure, and for those skilled in the art, other accompanying drawings can be obtained based on these accompanying drawings without creative work.

FIG. 1 is a schematic structural diagram of a pressure sensor, before being pressed, according to a first embodiment of this disclosure.

FIG. 2 is a circuit diagram of a pressure sensor according to the first embodiment of this disclosure.

FIG. 3 is a schematic structural diagram of the pressure sensor, when being pressed, according to the first embodiment of this disclosure.

FIG. 4 is a top view of the pressure sensor according to the first embodiment of this disclosure.

FIG. 5 is a schematic structural diagram of the first sensing gate in FIG. 4.

FIG. 6 is a schematic structural diagram of the first separation layer in FIG. 4.

FIG. 7 is a schematic structural diagram of the first active layer in FIG. 4.

FIG. 8 is a schematic structural diagram of the first electrode in FIG. 4.

FIG. 9 is a schematic structural diagram of the second electrode in FIG. 4.

FIG. 10 is a schematic structural diagram of the second sensing gate in FIG. 4.

FIG. 11 is a circuit diagram of a pressure sensing panel according to the first embodiment of this disclosure.

FIG. 12 is a flow chart of a method for manufacturing a pressure sensor according to the first embodiment of this disclosure.

FIG. 13 is a schematic structural diagram of a pressure sensor according to a second embodiment of this disclosure.

FIG. 14 is a schematic structural diagram of a pressure sensor according to a third embodiment of this disclosure.

FIG. 15 is a circuit diagram of a pressure sensor according to a fourth embodiment of this disclosure.

FIG. 16 is a schematic structural diagram of the pressure sensor according to the fourth embodiment of this disclosure.

100, sensing transistor; 200, switch transistor; 300, substrate;
10, cavity structure; 110, first active layer; 120, first sensing gate; 130, first insulating layer; 131, first separation layer; 1311, sacrificial etching hole; 132, first planarization layer; 140, first insulating cover layer; 150, first electrode; 160, second electrode; 170, second insulating layer; 171, first gate insulating layer; 172, first interlayer insulating layer; 180, second sensing gate; 190, first buffer layer; 20, pressing part;
210, second active layer; 220, first switch gate; 231, second separation layer; 232, second planarization layer; 240, second insulating cover layer; 250, third electrode; 260, fourth electrode; 271, second gate insulating layer; 272, second interlayer insulating layer; 280, second switch gate; 290, second buffer layer.

### DETAILED DESCRIPTION

Exemplary embodiments will now be described more fully with reference to the accompanying drawings. However, exemplary embodiments can be implemented in a variety of forms and should not be construed as limited to the examples set forth herein; rather, these embodiments are provided so that the disclosure will be more comprehensive and complete and to fully convey the concepts of the exemplary embodiments to those skilled in the art. The described features, structures, or characteristics may be combined in any suitable manner in one or more embodiments.

In addition, the accompanying drawings are only schematic illustrations of this disclosure and are not necessarily drawn to scale. The same reference numerals in the drawings represent the same or similar parts, and thus their repeated description will be omitted. Some of the block diagrams shown in the accompanying drawings are functional entities and do not necessarily correspond to physically or logically independent entities. These functional entities can be implemented in software form, or implemented in one or more hardware modules or integrated circuits, or implemented in different networks and/or processor devices and/or microcontroller devices.

### Embodiment I

Some embodiments of this disclosure provide a pressure sensor, as shown in FIG. 1, the pressure sensor includes a substrate 300 and a sensing transistor 100. The sensing transistor 100 is specifically a thin film transistor (TFT). The sensing transistor 100 includes a first active layer (Active) 110, a first sensing gate (Top Gate, TG) 120 and a cavity structure 10. The first active layer 110 is provided on the substrate 300, and the first active layer 110 can also be called a channel layer. The first sensing gate 120 is provided on the side of the first active layer 110 away from the substrate 300, and the cavity structure 10 is provided between the first active layer 110 and the first sensing gate 120 and overlaps with the first sensing gate 120.

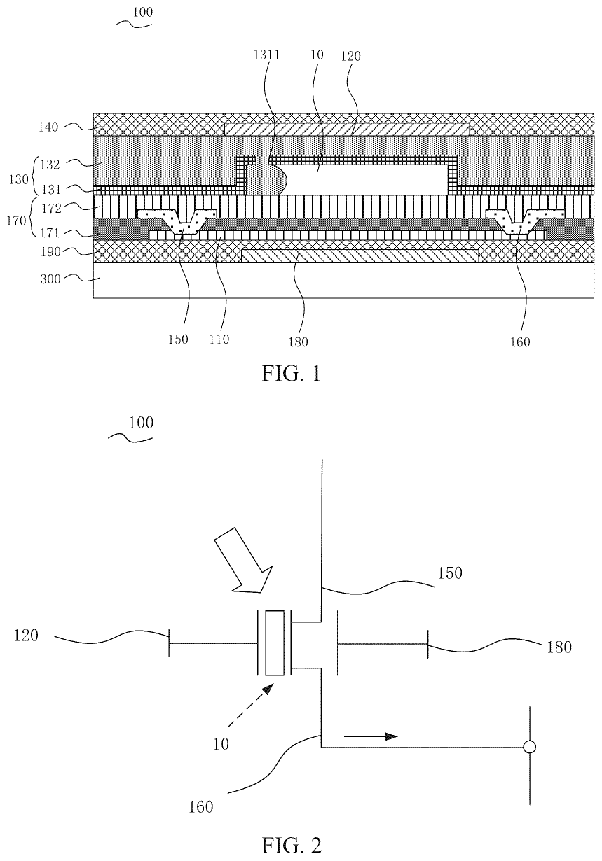

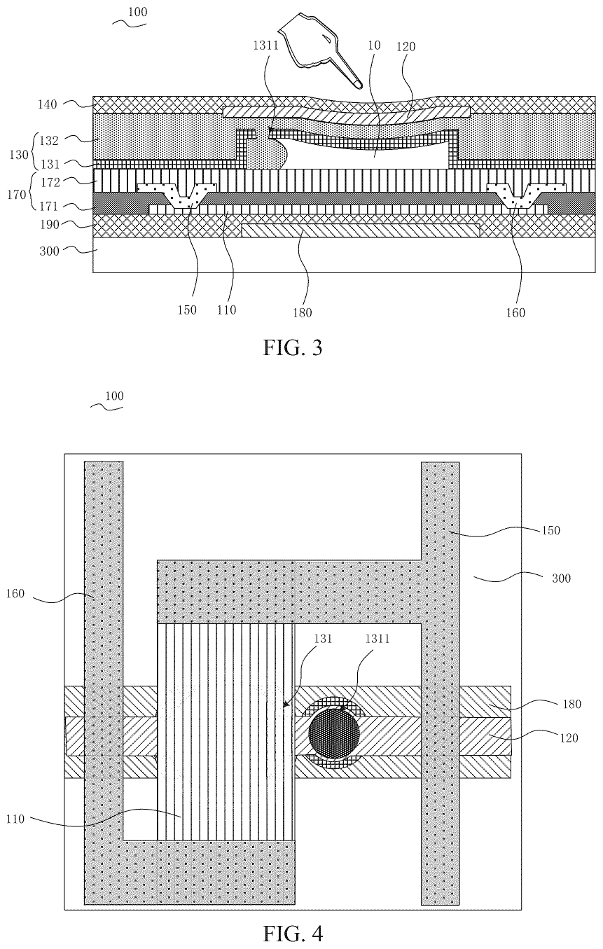

As shown in FIG. 2, after the scanning voltage is applied to the first sensing gate 120, a capacitor-like structure is formed between the first sensing gate 120 and the first active layer 110, where the first sensing gate 120 and the first active layer 110 are two plates of the capacitor structure. Since the capacitance of the parallel plate capacitor is C=εS/d, where ε is the relative dielectric constant, S is the facing area of the plates, and d is the distance between the two plates. As shown in FIG. 3, when the user presses the first sensing gate 120, the distance d between the two plates, the first sensing gate 120 and the first active layer 110, will change, causing the capacitance value per unit area of the first gate layer to also change.

According to the output current of the second electrode 160

$${I}_{D S} = \frac{1}{2} {μ}_{n} {C}_{o x} ( \frac{W}{L} ) {( {V}_{G S -} {V}_{T} )}^{2} ,$$

where μₙ is the mobility of carriers in the sensing transistor 100, Cₒₓ is the capacitance per unit area of the first sensing gate 120, V_{T} is the threshold voltage of the sensing transistor 100, W is the channel width of the sensing transistor 100, L is the channel length of the sensing transistor 100, V_{GS} is the voltage difference between the first sensing gate 120 and the second electrode 160. As the capacitance Cₒₓ per unit area of the first sensing gate 120 changes, the output current I_{DS} of the second electrode 160 also changes.

Therefore, according to the pressure sensor provided by some embodiments of this disclosure, the cavity structure 10 is formed between the first active layer 110 and the first sensing gate 120. Under the action of external pressure, the cavity structure 10 is deformed, causing the capacitance value between the first active layer 110 and the first sensing gate 120 to change, and the output current of the second electrode 160 in the sensing transistor 100 changes. According to the output current of the second electrode 160, the pressing force of the first sensing gate 120 can be detected. The output current of the second electrode 160 is different when the pressing force applied to the first sensing gate 120 is different, thereby realizing the detection of different pressing forces. Since the capacitance change directly acts on the first sensing gate 120 of the sensing transistor 100, the voltage and current signals are converted and amplified, thereby improving the sensitivity of the pressure sensor. In addition, the pressure sensor can realize the detection of pressing force only through the cavity structure 10, without the need for complex special materials, thereby saving production costs.

Exemplarily, when the user presses the first sensing gate 120, the first sensing gate 120 approaches the first active layer 110, and the distance d between the two corresponding plates, the first sensing gate 120 and the first active layer 110, becomes smaller, and the capacitance value Cₒₓ per unit area of the first gate layer becomes larger, thereby increasing the output current I_{DS} of the second electrode 160. So the current sensed by the external detection circuit is also larger, which plays a role in improving the strength of the detection signal and improving the sensitivity of the pressure sensor.

It should be particularly noted that the pressure sensor provided in some embodiments can be applied to intelligent pressure-sensitive surfaces. Specifically, the pressure sensor can be applied to the intelligent skin of a robot, or the pressure sensor can be applied to biometric fields such as fingerprint recognition. For example, pressure detection can be performed on the device surface according to the different pressures at the positions of valleys and ridges in the fingerprint, or the pressure sensor can be applied to intelligent medical fields related to human health. For example: for human activities such as breathing, heartbeat, blood flow, and expansion and contraction of the lungs, the pressure sensor effectively converts the mechanical energy generated by these human activities into electrical signals to realize the detection of various health indicators of the human body.

In some embodiments, as shown in FIG. 1, the substrate 300 may be a flexible substrate, such as plastic, glass, etc. The plastic may be polyimide, and the use of glass-based technology may achieve large-area and array formation to meet the large-size requirements of users.

In some embodiments, the orthographic projection of the cavity structure 10 on the substrate 300 is located within the orthographic projection of the first active layer 110 on the substrate 300.

In this way, the size of the first active layer 110 is larger than that of the cavity structure 10, and the first active layer 110 can provide a relatively large and complete plane for the side of the cavity structure 10 facing the substrate 300. In other words, the bottom of the cavity structure 10 has good basic stability, which facilitates the formation of the cavity structure 10 above the first active layer 110. At the same time, it can also ensure that the height of the cavity structure 10 has a certain stability.

The first active layer 110 may be made of materials such as amorphous silicon, polycrystalline silicon and oxide, for example, indium gallium zinc oxide.

In some embodiments, as shown in FIG. 1 and FIG. 4, the boundary of the orthographic projection of the cavity structure 10 on the substrate 300 is located inside the boundary of the orthographic projection of the first sensing gate 120 on the substrate 300. Any pressing force borne by the first sensing gate 120 can cause the deformation of the cavity structure 10, thereby improving the detection sensitivity of the pressure sensor.

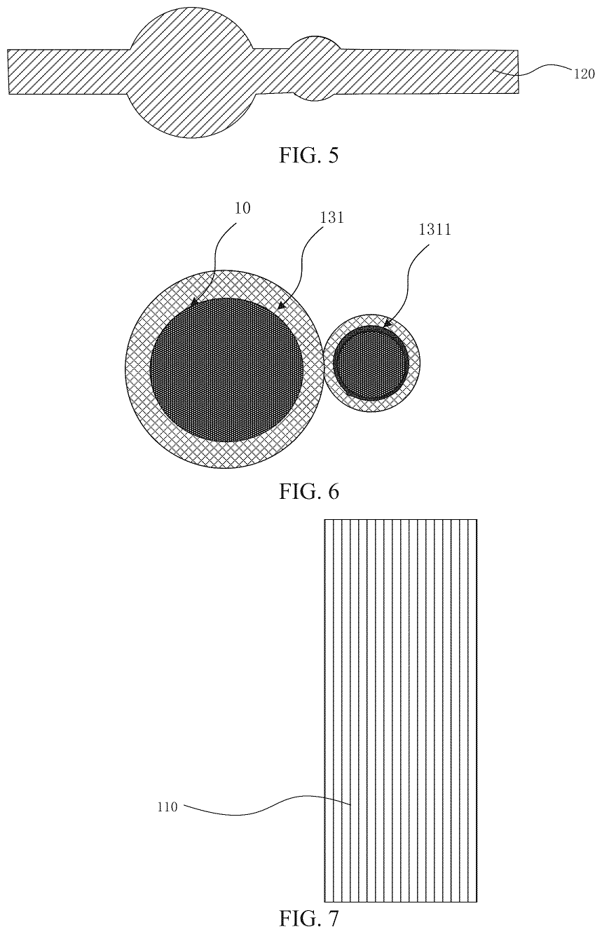

Specifically, as shown in FIG. 4 to FIG. 6, the first sensing gate 120 includes a base portion and a functional portion, where the base portion is provided on the side of the first active layer 110 away from the substrate 300, and the functional portion is connected to the base portion. The first top gate has a base portion and a functional portion, a basic planar capacitor is formed between the base portion and the first active layer 110, and the functional portion corresponds to the cavity structure 10. When the functional portion is pressed, the cavity structure 10 is deformed, so that the capacitance value between the first sensing gate 120 and the first active layer 110 changes.

The projection of the functional portion relative to the substrate 300 coincides with the projection of the cavity structure 10 relative to the substrate 300. That is, the size of the functional portion is the same as the size of the cavity structure 10. Any pressing force borne by the functional portion can cause the deformation of the cavity structure 10, thereby improving the detection sensitivity of the pressure sensor.

In some embodiments, as shown in FIG. 1, the sensing transistor 100 further includes a first insulating layer 130, which is provided between the first active layer 110 and the first sensing gate 120. In this manner, the first insulating layer 130 plays the role of isolation and insulation between the first active layer 110 and the first sensing gate 120, thereby preventing electrical contact between the first active layer 110 and the first sensing gate 120.

In some embodiments, the sensing transistor 100 further includes a second insulating layer 170, which covers the first active layer 110 and overlaps with the cavity structure 10. In this way, the second insulating layer 170 plays the role of isolation and insulation between the first active layer 110 and the first insulating layer 130, thereby further preventing electrical contact between the first active layer 110 and the first sensing gate 120.

At least part of the cavity structure 10 is provided inside at least one of the first insulating layer 130 and the second insulating layer 170.

Specifically, the cavity structure 10 may be entirely provided in the first insulating layer 130, or the cavity structure 10 may be entirely provided in the second insulating layer 170, or the cavity structure 10 may be a space enclosed by the first insulating layer 130 and the second insulating layer 170.

In some embodiments, the first insulating layer 130 includes a first separation layer 131, and the first separation layer 131 is provided between the first active layer 110 and the first sensing gate 120. The first separation layer 131 can separate the first active layer 110 from the first sensing gate 120, and is used for isolation and insulation between the first active layer 110 and the first sensing gate 120, thereby preventing electrical contact between the first active layer 110 and the first sensing gate 120, so as to ensure that the sensing transistor 100 can work normally.

The first separation layer 131 is provided with a sacrificial etching hole 1311, the sacrificial etching hole 1311 is connected to the cavity structure 10, and the cavity structure 10 is provided in the first separation layer 131.

Specifically, the cavity structure 10 can be formed by etching a sacrificial layer. The sacrificial layer is first placed between the second insulating layer 170 and the first separation layer 131. The second insulating layer 170, the sacrificial layer and the first separation layer 131 are stacked in sequence. The sacrificial layer can be made of gold materials such as copper and molybdenum, or can be made of an organic polymer material. The thickness of the sacrificial layer is about 100 nm to 1500 nm. Then, a sacrificial etching solution is flowed into the sacrificial etching hole 1311, causing the sacrificial etching solution to enter between the first separation layer 131 and the second insulating layer 170 and to corrode the sacrificial layer The sacrificial layer, serving as a lower thin film, plays the role of a separation layer, thereby obtaining the cavity structure 10 between the first separation layer 131 and the first active layer 110.

In some other embodiments, the cavity structure 10 may be formed in a variety of manners. For example, the second insulating layer 170 may be recessed in the direction toward the substrate 300 to form a receiving groove, which is used to receive and fill the sacrificial layer. Subsequently, the first insulating layer 130 having the sacrificial etching hole 1311 is used to cover the receiving groove, and then the sacrificial layer is removed. Accordingly, the cavity structure 10 is provided in the second insulating layer 170. Alternatively, the second insulating layer 170 may be recessed in the direction toward the substrate 300 to form a receiving groove, and the first insulating layer 130 may be recessed in the direction away from the substrate 300 to form a filling groove, and the receiving groove and the filling groove are connected to form a receiving space, which is used to fill the sacrificial layer. After the sacrificial layer is removed, the cavity structure 10 is provided between the first insulating layer 130 and the second insulating layer 170.

In some embodiments, as shown in FIG. 4 to FIG. 7, the orthographic projection of the sacrificial etching hole 1311 on the substrate 300 is located outside the orthographic projection of the first active layer 110 on the substrate 300. In this way, the opening and blocking position of the sacrificial etching hole 1311 are staggered from the position of the cavity structure 10, thereby improving the structural strength and stability of the cavity structure 10.

Alternatively, it is also possible that the orthographic projection of the sacrificial etching hole 1311 on the substrate 300 is located inside the orthographic projection of the first active layer 110 on the substrate 300. The embodiments do not limit the position of the sacrificial etching hole 1311 relative to the cavity structure 10, which can be adjusted according to actual production conditions. In addition, FIG. 1 and FIG. 4 present the structures of respective film layer sin two different forms, with some, but not all, structures correspond to each other.

If there is only one sacrificial etching hole 1311, the etching solution may only be introduced through one sacrificial etching hole 1311, resulting in a relatively long etching time of the sacrificial layer. To solve this problem, there are multiple sacrificial etching holes 1311, and multiple sacrificial etching holes 1311 are provided corresponding to the cavity structure 10. In this way, the etching solution can be introduced into multiple sacrificial etching holes 1311 at the same time, thereby increasing the amount of introduced etching solution, shortening the etching time of the sacrificial layer, and thus improving the production efficiency.

In some embodiments, the first separation layer 131 includes a main body and a protrusion, where the main body is provided between the first active layer 110 and the first sensing gate 120. The protrusion is connected to the main body and protrudes on a side of the main body away from the substrate 300. The sacrificial etching hole 1311 is provided in the protrusion, and the protrusion and the second insulating layer 170 form the cavity structure 10.

The main body is a flat structure, and the protrusion is provided protruding from the main body, so the first separation layer 131 is an uneven structure as a whole. As the uneven structure is fully utilized, the region between the protrusion and the second insulating layer 170 can accommodate the sacrificial layer. The sacrificial etching hole 1311 is provided in the protrusion, so that the sacrificial etching hole 1311 corresponds to the sacrificial layer. When the etching solution is injected from the sacrificial etching hole 1311, the sacrificial layer can be directly corroded, so that the cavity structure 10 is formed in the space where the sacrificial layer was originally placed.

In some embodiments, as shown in FIG. 1, the first insulating layer 130 further includes a first planarization layer 132. The first planarization layer 132 is provided between the first separation layer 131 and the first sensing gate 120 and can block the sacrificial etching hole 1311.

The first planarization layer 132 may be made of an organic polymer material, such as photoresist. Since the sacrificial etching hole 1311 serves as a process hole, the side of the first planarization layer 132 facing the substrate 300 can block the sacrificial etching hole 1311, so that the cavity structure 10 is a closed structure. At the same time, the side of the first planarization layer 132 away from the substrate 300 is a flat structure, which is convenient for forming and placing the first sensing gate 120.

It can be understood that the first planarization layer 132 can also extend to the interior of the cavity structure 10, but will not fill the cavity structure 10. The portion of the first planarization layer 132 extending to the interior of the cavity structure 10 can contact the second insulating layer 170, and to a certain extent play a role in supporting a part of the first planarization layer 132 located outside the cavity structure 10.

In some embodiments, the projection of the cavity structure 10 relative to the substrate 300 is a circular structure.

Compared with the rectangular parallelepiped structure, the inner wall of the cavity structure 10, which adopts a structure similar to the cylinder, has no dead angle, thereby being convenient for flow of the etching solution and rapid formation of the cavity structure 10. Accordingly, after the cavity structure 10 is formed, the circumferential force on the inner wall of the cavity structure 10 is uniform, thereby improving the structural stability of the cavity structure 10.

In some embodiments, the cavity structure 10 may be filled with gas, and the gas may be air, which has a relatively low production cost. Alternatively, the cavity structure 10 is a vacuum structure, and the cavity structure 10 may be evacuated through the sacrificial etching hole 1311, thereby extending the service life of the cavity structure 10.

In some embodiments, as shown in FIG. 1, the sensing transistor 100 further includes a first insulating cover layer 140. The first insulating cover layer 140 is provided on a side of the first insulating layer 130 away from the substrate 300, and covers the first sensing gate 120.

Since the first sensing gate 120 is to be pressed, by covering the first sensing gate 120 through the first insulating cover layer 140, the first sensing gate 120 can be prevented from being directly exposed. The first insulating cover layer 140 serves to isolate and protect the first sensing gate 120.

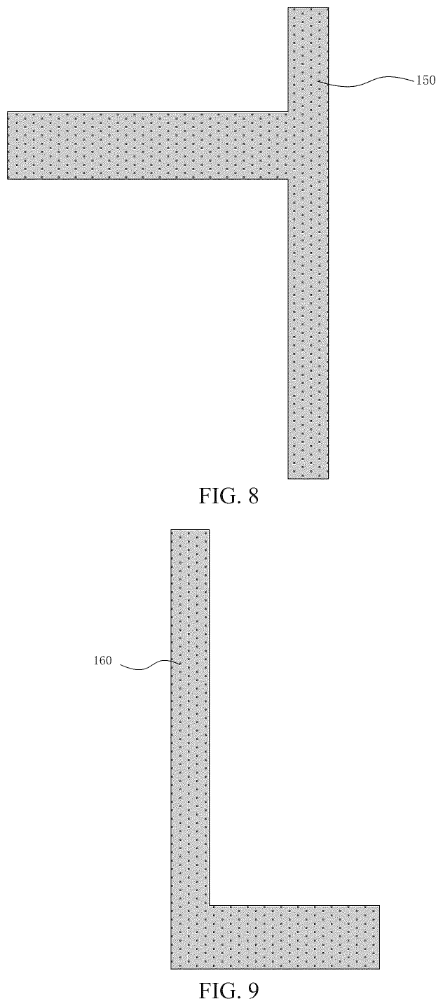

In some embodiments, as shown in FIG. 1, FIG. 4, and FIG. 7 to FIG. 9, the sensing transistor 100 further includes a first electrode 150 and a second electrode 160, which are provided on a surface of the second insulating layer 170 facing the substrate 300 and are electrically connected to the first active layer 110 through a via(s).

The first electrode 150 is specifically a source electrode (S), and the second electrode 160 is specifically a drain electrode (D). The first electrode 150 and the second electrode 160 can be made of one of molybdenum, copper, aluminum, titanium and niobium, or a combination of two or more of them; they can also be made of a transparent electrode material, such as indium tin oxide (ITO). The first electrode 150 can be connected to a data line for applying a driving voltage, and the second electrode 160 can be connected to an output line for outputting a current.

In some embodiments, the second insulating layer 170 specifically includes a first gate insulating layer (Gate insulator, GI1) 171, which is provided on a side of the first active layer 110 away from the substrate 300. The first electrode 150 and the second electrode 160 are electrically connected to the first active layer 110 across the first gate insulating layer 171.

The first gate insulating layer 171 serves to isolate and insulate the first active layer 110. The first electrode 150 and the second electrode 160 may only need to pass through one layer of the first gate insulating layer 171 before being electrically connected to the first active layer 110. In other words, a via(s) is only to be opened in one insulating layer, thereby having a simple process and high production efficiency.

Since the first electrode 150 and the second electrode 160 are conductive, they are generally made of metal materials. If the sacrificial layer is made of metal materials, when the etching solution corrodes the sacrificial layer, the etching solution is likely to corrode the first electrode 150 and the second electrode 160 as well, thus affecting the use of the first electrode 150 and the second electrode 160.

In order to solve this problem, the sensing transistor 100 further includes a first interlayer insulating layer (ILD) 172. The first interlayer insulating layer 172 is provided between the first gate insulating layer 171 and the first insulating layer 130. The first interlayer insulating layer 172 covers the first electrode 150 and the second electrode 160. The first interlayer insulating layer 172 and the first insulating layer 130 are close to each other on one side to form the cavity structure 10, thereby ensuring the insulation of the cavity structure 10.

In this way, the first interlayer insulating layer 172 can isolate and protect the first electrode 150 and the second electrode 160, and the etching solution will only corrode the sacrificial layer but not the first electrode 150 and the second electrode 160, thereby ensuring that the first electrode 150 and the second electrode 160 will not be affected during the formation of the cavity structure 10, thus ensuring the reliability of the first electrode 150 and the second electrode 160.

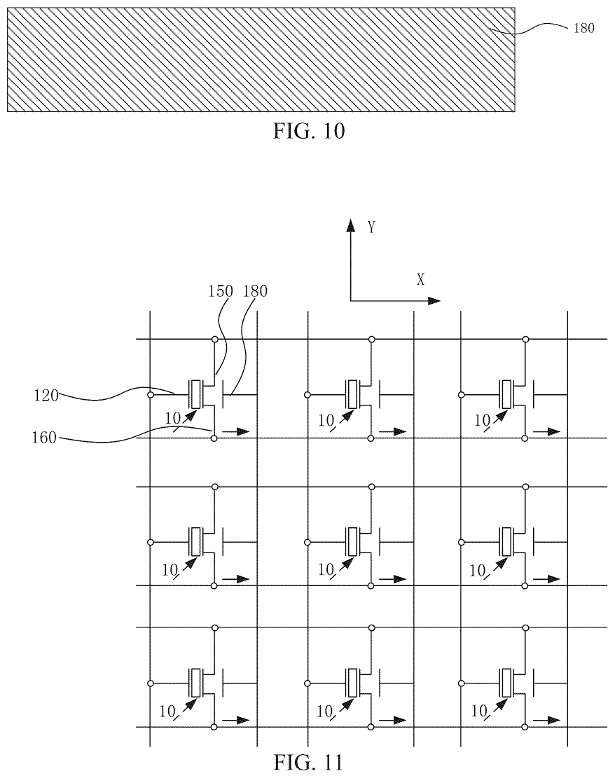

In some embodiments, as shown in FIG. 1, FIG. 4 and FIG. 10, the sensing transistor 100 further includes a second sensing gate 180, which is provided between the first active layer 110 and the substrate 300 and overlaps with the first active layer 110. The overlapping between the second sensing gate 180 and the first active layer 110 specifically means that the orthographic projection of the second sensing gate 180 on the substrate 300 at least partially overlaps with the orthographic projection of the first active layer 110 on the substrate 300.

The second sensing gate 180 can be used to independently control the sensing transistor 100 to work in a certain initial state. When external pressure is applied to the first sensing gate 120, the capacitance value between the first sensing gate 120 and the first active layer 110 changes, thereby changing the output current of the second electrode 160 in the sensing transistor 100. Under the joint action of the second sensing gate 180 and the first sensing gate 120, even if the first sensing gate 120 is subjected to pressure, the working stability and control flexibility of the sensing transistor 100 can be guaranteed.

In some embodiments, the first sensing gate 120 and the second sensing gate 180 can be applied with different driving voltages to achieve different electrical driving signals, so as to facilitate more flexible control of the state of the sensing transistor 100. Alternatively, the first sensing gate 120 and the second sensing gate 180 can also be connected together to apply the same electrical driving signal.

The first sensing gate 120 and the second sensing gate 180 can be made of one of molybdenum, copper, aluminum, titanium and niobium, or a combination of two or more thereof.

In some embodiments, the sensing transistor 100 further includes a first buffer layer (Buffer) 190. The first buffer layer 190 covers the second sensing gate 180. The first active layer 110 is provided on a surface of the first buffer layer 190 away from the substrate 300.

The first buffer layer 190 is used to protect the thin film transistor, so as to ensure that the first active layer 110 is separated from the substrate 300, thereby preventing the impurities of the substrate 300 from affecting the thin film transistor, and ensuring that the thin film transistor can work normally. Exemplarily, the first buffer layer 190 can be a silicon oxide layer, a silicon nitride layer, or a silicon oxynitride layer, so as to ensure the insulation effect of the first buffer layer 190, and to separate the first active layer 110 from the substrate 300.

The first buffer layer 190, the first separation layer 131, the first planarization layer 132, the first insulating cover layer 140, the first gate insulating layer 171 and the first interlayer insulating layer 172 can all be made of materials such as silicon nitride, silicon oxide and the like. The first planarization layer 132 and the first insulating cover layer 140 can also be made of organic polymer materials, for example, photoresist, or epoxy resins such as SU-8.

Some embodiments further provide a pressure sensing panel, including the above-mentioned pressure sensor.

The pressure sensor according to some embodiments has the above-mentioned pressure sensor, where the output current of the second electrode 160 is different when the pressing force applied to the first sensing gate 120 is different, thereby realizing the detection of different pressing forces. Since the capacitance change directly acts on the first sensing gate 120 of the sensing transistor 100, the voltage and current signals are converted and amplified, thereby improving the sensitivity of the pressure sensor.

In some embodiments, as shown in FIG. 11, there are multiple sensing transistors 100, and multiple pressure sensors are provided in an array along the row direction and the column direction. The top gates of the sensing transistors 100 in the same column are connected through a scan line, the first electrodes 150 of the sensing transistors 100 in the same row are connected through a data line, and the second electrodes 160 of the sensing transistors 100 in the same row are connected through an output line. The row direction and the column direction are two directions that intersect and are perpendicular to each other, not specifically referring to the vertical direction and the horizontal direction. The row direction is marked with an X, and the column direction is marked with a Y.

Since one sensing transistor 100 corresponds to one pixel, multiple sensing transistors 100 are provided in an array to form an pixel array. The scan line can apply a top gate scanning voltage to the top gates of the same column, and the data line can apply a data voltage to the first electrodes 150 of the same row. Finally, the second electrodes 160 of each row output current through the data line.

It is understandable that if the sensing transistor 100 has a second sensing gate 180, the bottom gates of the sensing transistors 100 in the same column are connected through a scan line, that is, the scan line can apply a bottom gate scanning voltage to the bottom gates in the same column. Alternatively, the first sensing gate 120 and the second sensing gate 180 may be provided with different scanning voltages to achieve different electrical driving signals, so as to facilitate more flexible control of the state of the sensing transistor 100.

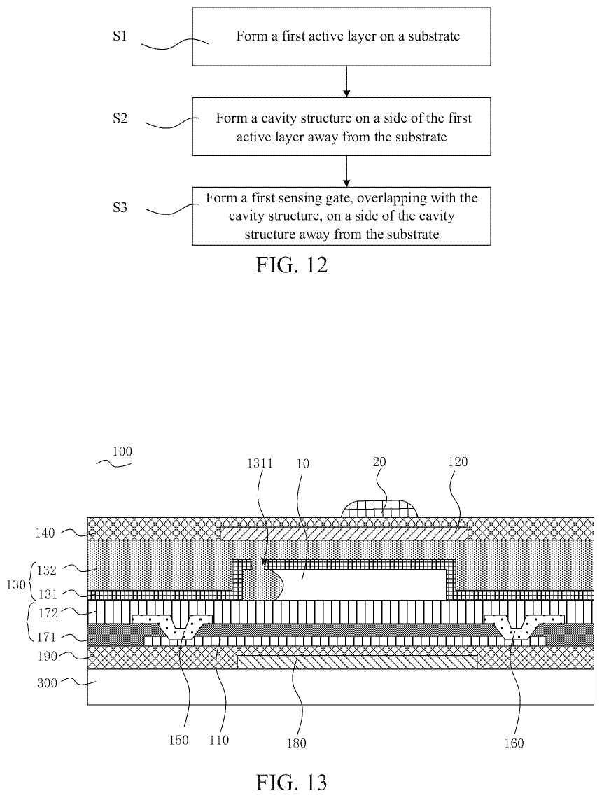

As shown in FIG. 12, some embodiments further provide a method for manufacturing a pressure sensor, which includes the following steps.

In S1, a first active layer 110 is formed on a substrate 300.

In S2, a cavity structure 10 is formed on a side of the first active layer 110 away from the substrate 300.

In S3, a first sensing gate 120, overlapping with the cavity structure 10, is formed on a side of the cavity structure 10 away from the substrate 300.

According to the pressure sensor manufacturing method provided in some embodiments, there is no need to change the existing process or use complex special materials. It may only need to form the cavity structure 10 on the side of the first active layer 110 away from the substrate 300. While realizing the pressure sensor, it can also realize the function of pressure detection, and the production cost is relatively low.

In some embodiments, forming the cavity structure 10 on the side of the first active layer 110 away from the substrate 300 includes the following steps:
forming a second insulating layer 170 on a side of the first active layer 110 away from the substrate 300;
forming a sacrificial layer, overlapping with the first sensing gate 120 and the second insulating layer 170, on a side of the second insulating layer 170 away from the substrate 300;
forming a first insulating layer 130 for covering the sacrificial layer on a side of the sacrificial layer away from the substrate 300; and
removing the sacrificial layer to form a cavity structure 10 between the first insulating layer 130 and the second insulating layer 170.

In this way, as long as the position of the sacrificial layer relative to the first sensing gate 120 and the second insulating layer 170, as well as the contour and shape of the sacrificial layer, is set, the cavity structure 10 corresponding to the sacrificial layer can be obtained after removing the sacrificial layer. Accordingly, the position of the sacrificial layer is the position of the cavity structure 10, and the outer contour and shape of the sacrificial layer are the inner contour and shape of the cavity structure 10. In addition, the first insulating layer 130 covers the sacrificial layer, and after removing the sacrificial layer, a cavity structure 10 with a closed structure is formed between the first insulating layer 130 and the second insulating layer 170.

In some embodiments, removing the sacrificial layer includes the following steps:
forming a first separation layer 131 on a side of the sacrificial layer away from the substrate 300;
forming a sacrificial etching hole 1311 on the first separation layer 131;
introducing an etching solution into the sacrificial etching hole 1311, so that the etching solution corrodes the sacrificial layer, thereby forming the cavity structure 10 between the first separation layer 131 and the second insulating layer 170; and
forming a first planarization layer 132 for blocking the sacrificial etching hole 1311 on a side of the first separation layer 131 away from the substrate 300.

When the sacrificial etching solution passes through the sacrificial etching hole 1311 and enters between the first separation layer 131 and the second insulating layer 170, the sacrificial etching solution corrodes the sacrificial layer. The sacrificial layer, serving as a lower thin film, plays the role of a separation layer, thereby obtaining the cavity structure 10 between the first separation layer 131 and the second insulating layer 170. In this process, the sacrificial layer will not corrode the first separation layer 131, that is, it will not damage the internal microstructure of the sensing transistor 100, thereby ensuring the reliability of the sensing transistor 100. Since the sacrificial etching hole 1311 acts as a process hole, the side of the first planarization layer 132 facing the substrate 300 can block the sacrificial etching hole 1311, so that the cavity structure 10 is a closed structure. In addition, the side of the first planarization layer 132 away from the substrate 300 is a flat structure, which is convenient for forming and placing the first sensing gate 120.

It should be noted that, although the steps of the pressure sensor manufacturing method in this disclosure are described in a specific order in the accompanying drawings, this does not require or imply that the steps must be performed in this specific order, or that all the steps shown must be performed to achieve the desired results. Additionally or alternatively, some steps may be omitted, multiple steps may be combined into one step, and/or one step may be decomposed into multiple steps.

### Embodiment II

This embodiment is similar to Embodiment I, and the only difference is that the specific structure of the first insulating cover layer 140 is different.

As shown in FIG. 13, the sensing transistor 100 further includes a pressing portion 20, which is provided on a side of the first sensing gate 120 away from the substrate 300 and corresponding to the cavity structure 10. The pressing portion 20 is more conducive to effectively transmitting the external pressing force to the cavity structure 10, thereby facilitating deformation of the cavity structure 10.

In some embodiments, the pressing portion 20 is a protruding structure, where the size of the protruding structure may be micrometer-level, and the pressing portion 20 is specifically protrudingly provided on a side of the cover insulating layer away from the first sensing gate 120, so as to facilitate the application of external pressure and force transmission.

In some embodiments, the orthographic projection shape of the protruding structure on the substrate 300 may be a triangle, a circle, and the like. There are many choices for the shape, which is not limited in the embodiments.

In some embodiments, the protruding structure may be made of silicon nitride, silicon oxide or an organic polymer material, but the protruding structure cannot be made of the same material as the first insulating cover layer 140, so as to ensure compatibility during the etching process.

### Embodiment III

This embodiment is similar to Embodiment I, and the only difference is the number of cavities.

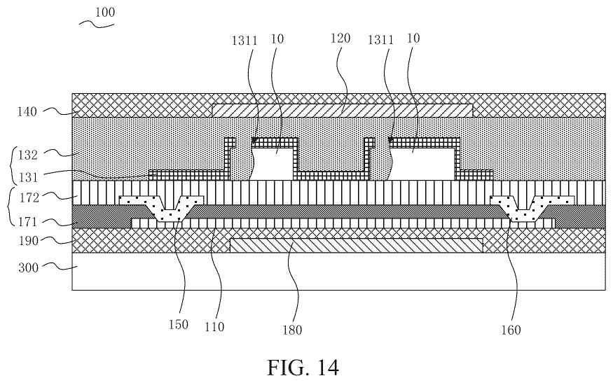

As shown in FIG. 14, the pressure sensor provided in some embodiments has a plurality of cavity structures 10, and the plurality of cavity structures 10 are provided in parallel and spaced apart between the first active layer 110 and the first sensing gate 120. The orthographic projections of the plurality of cavity structures 10 on the substrate 300 are located inside the orthographic projections of the first sensing gate 120 on the substrate 300.

Specifically, the cavity structure 10 may have other deformed structures. When there are multiple cavity structures 10, it is equivalent to dividing a relatively large cavity structure 10 into multiple relatively small sub-cavities. The multiple cavity structures 10 correspond to the first sensing gate 120, so as to withstand the pressing force applied to the first sensing gate 120, thereby improving the sensitivity of the pressure sensor.

### Embodiment IV

This embodiment is similar to Embodiment I, and the only difference is the structure of the pressure sensing panel.

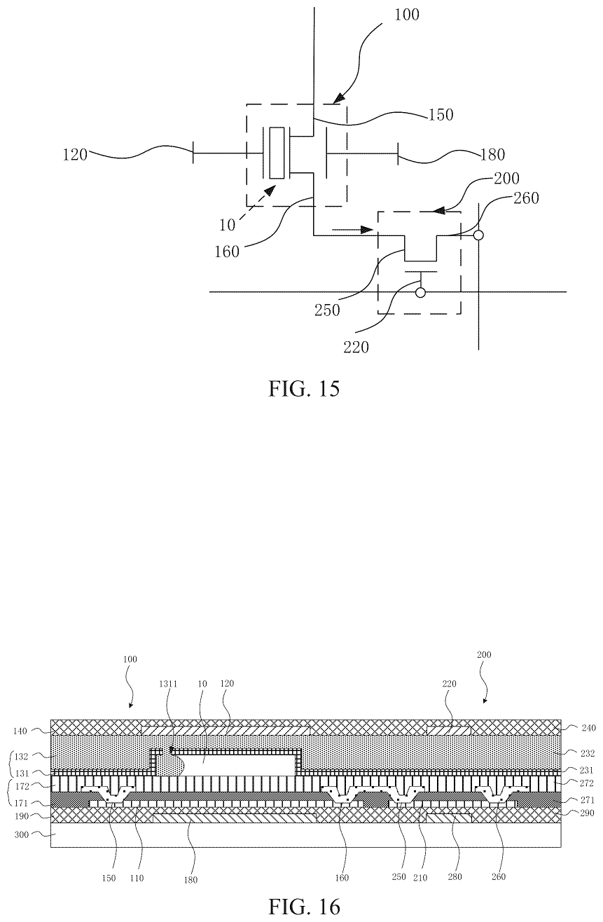

As shown in FIG. 15, the pressure sensing panel provided in some embodiments further includes a switch transistor 200. The switch transistor 200 is provided on the substrate 300. The second electrode 160 of the sensing transistor 100 is connected to an output line through the switch transistor 200.

In the pressure sensing panel according to some embodiments, each pixel has two thin film transistors. The sensing transistor 100 has a cavity structure 10 and is a pressure sensing part. The switch transistor 200 does not have a cavity structure 10 and only plays a switch control role.

In some embodiments, the switch transistor 200 further includes a third electrode 250 and a fourth electrode 260. The second electrode 160 of the sensing transistor 100 is connected to the third electrode 250 of the switch transistor 200, the fourth electrode 260 of the switch transistor 200 is connected to the output line, and the gate of the switch transistor 200 is connected to the scan line.

The switch transistor 200 acts as a control switch, which is turned on and off at a certain time interval. When the scan line applies a gate scanning signal to the switch transistor 200, the switch transistor 200 is turned on, and the output current in the sensing transistor 100 can be read by an external detection circuit. The external detection circuit can accurately determine the trigger signal sensed by the pressure sensor based on the change in the read current value.

In some embodiments, as shown in FIG. 16, the switch transistor 200 includes a second active layer 210 and a first switch gate 220. The second active layer 210 is provided on the substrate 300, the second active layer 210 is electrically connected to the first active layer 110, and the first switch gate 220 is provided on a side of the second active layer 210 away from the substrate 300. By utilizing the electrical connection between the first active layer 110 and the second active layer 210, the switch transistor 200 can control the sensing transistor 100.

Specifically, the second active layer 210 is provided in the same layer as the first active layer 110, and the first switch gate 220 is provided in the same layer as the first sensing gate 120. The same layer arrangement may specifically refer to different regions of the same film layer having the same material, which can be formed simultaneously through the same patterning process, thereby simplifying the manufacturing process and improving production efficiency.

In some embodiments, as shown in FIG. 16, the switch transistor 200 further includes a second switch gate 280, a second buffer layer 290, a second gate insulating layer 271, a second interlayer insulating layer 272, a second separation layer 231, a second planarization layer 232 and a second insulating cover layer 240.

In some embodiments, the second switch gate 280, the second buffer layer 290, the second active layer 210, the second gate insulating layer 271, the third electrode 250, the fourth electrode 260, the second interlayer insulating layer 272, the second separation layer 231, the second planarization layer 232, the second gate insulating layer 271 and the second insulating cover layer 240 are stacked in sequence. Except for the cavity structure 10, other layers are correspondingly provided in the sensing transistor 100 and the switch transistor 200, and the other layers can be provided in the same layer or in different layers.

It should be noted that the switch transistor 200 according to some embodiments may also have only the first switch gate 220, but not the second switch gate 280. Alternatively, the first switch gate 220 may also be provided between the second gate insulating layer 271 and the second interlayer insulating layer 272, or between the second gate insulating layer 271 and the second separation layer 231, or between the second separation layer 231 and the second planarization layer 232.

It should be noted that the embodiments do not limit the positions of the first electrode 150, the second electrode 160, the third electrode 250 and the fourth electrode 260. Respective electrodes are not necessarily provided between the corresponding gate insulating layer and the interlayer insulating layer, but may also be provided between other adjacent insulating layers.

Those skilled in the art will readily appreciate other embodiments of this disclosure after considering the specification and practicing the invention disclosed herein. This disclosure is intended to cover any variations, uses or adaptations of this disclosure, which follow the general principles of this disclosure and include common knowledge or customary techniques in the art that are not disclosed in this disclosure. The description and examples are intended to be exemplary only, and the true scope and spirit of this disclosure are indicated by the appended claims.

What is claimed is:

1. A pressure sensor, comprising a substrate and a sensing transistor, wherein the sensing transistor comprises:
a first active layer, provided on the substrate;
a first sensing gate, provided on a side of the first active layer away from the substrate; and
a cavity structure, provided between the first active layer and the first sensing gate, and overlapping with the first sensing gate.

2. The pressure sensor according to claim 1, wherein the sensing transistor further comprises:
a first insulating layer, provided between the first active layer and the first sensing gate and overlapping with the cavity structure; and
a second insulating layer, covering the first active layer and overlapping with the cavity structure;
wherein, at least part of the cavity structure is provided inside at least one of the first insulating layer and the second insulating layer.

3. The pressure sensor according to claim 2, wherein the first insulating layer comprises:
a first separation layer, provided between the first active layer and the first sensing gate;
wherein, the first separation layer is provided with a sacrificial etching hole, the sacrificial etching hole is connected with the cavity structure, and the cavity structure is provided in the first separation layer.

4. The pressure sensor according to claim 3, wherein the first separation layer comprises:
a main body, provided between the first active layer and the first sensing gate; and
a protrusion, protrudingly provided on a side of the main body away from the substrate, wherein the sacrificial etching hole is provided in the protrusion, and the cavity structure is defined by the protrusion and the second insulating layer.

5. The pressure sensor according to claim 3, wherein an orthographic projection of the sacrificial etching hole on the substrate is located outside an orthographic projection of the first active layer on the substrate.

6. The pressure sensor according to claim 3, wherein the first insulating layer further comprises:
a first planarization layer, provided between the first separation layer and the first sensing gate and configured to block the sacrificial etching hole.

7. The pressure sensor according to claim 2, wherein the sensing transistor further comprises:
a first insulating cover layer, provided on a side of the first insulating layer away from the substrate and configured to cover the first sensing gate.

8. The pressure sensor according to claim 2, wherein the sensing transistor further comprises:
a first electrode and a second electrode, provided on a surface of the second insulating layer facing the substrate and electrically connected to the first active layer through a via.

9. The pressure sensor according to claim 8, wherein the second insulating layer comprises:
a first gate insulating layer, provided on a side of the first active layer away from the substrate, wherein the first electrode and the second electrode are electrically connected to the first active layer across the first gate insulating layer; and
a first interlayer insulating layer, provided between the first gate insulating layer and the first insulating layer and configured to cover the first electrode and the second electrode, wherein the cavity structure is defined by sides, close to each other, of the first interlayer insulating layer and the first insulating layer.

10. The pressure sensor according to claim 1, wherein the sensing transistor further comprises:
a second sensing gate, provided between the first active layer and the substrate, and overlapping with the first active layer; and
a first buffer layer, covering the second sensing gate, wherein the first active layer is provided on a surface of the first buffer layer away from the substrate.

11. The pressure sensor according to claim 1, wherein an orthographic projection of the cavity structure on the substrate is located within an orthographic projection of the first active layer on the substrate.

12. The pressure sensor according to claim 1, wherein a boundary of an orthographic projection of the cavity structure on the substrate is located within a boundary of an orthographic projection of the first sensing gate on the substrate.

13. The pressure sensor according to claim 1, wherein a projection of the cavity structure relative to the substrate is a circular structure.

14. The pressure sensor according to claim 1, wherein the cavity structure is filled with gas; or,
the cavity structure is a vacuum structure.

15. The pressure sensor according to claim 1, wherein the sensing transistor further comprises:
a pressing portion, provided on a side of the first sensing gate away from the substrate and provided corresponding to the cavity structure.

16. The pressure sensor according to claim 1, wherein a number of the cavity structure is two or more, the two or more cavity structures are provided in parallel and spaced apart between the first active layer and the first sensing gate, and orthographic projections of the cavity structures on the substrate are located within an orthographic projection of the first sensing gate on the substrate.

17. A pressure sensing panel, characterized in comprising a pressure sensor, wherein the pressure sensor comprises a substrate and a sensing transistor, and the sensing transistor comprises:
a first active layer, provided on the substrate;
a first sensing gate, provided on a side of the first active layer away from the substrate; and
a cavity structure, provided between the first active layer and the first sensing gate, and overlapping with the first sensing gate.

18. The pressure sensing panel according to claim 17, wherein a number of the pressure sensor is two or more, and the two or more pressure sensors are arranged in an array along a row direction and a column direction, with top gates of sensing transistors in a same column being connected through a scan line, first electrodes of the sensing transistors in a same row being connected through a data line, and second electrodes of the sensing transistors in the same row being connected through an output line.

19. The pressure sensing panel according to claim 18, further comprising:
a switch transistor, provided on the substrate, wherein the second electrodes of the sensing transistors are connected to the output line through the switch transistor.

20. The pressure sensing panel according to claim 19, wherein the switch transistor comprises:
a second active layer, provided on the substrate, wherein the second active layer is electrically connected to the first active layer and provided in a same layer as the first active layer; and
a first switch gate, provided on a side of the second active layer away from the substrate and provided in a same layer as the first sensing gate.
